(19) United States
(12) Patent Application Publication
(10) Pub. No.: US 2026/0255213 A1
(43) Pub. Date: Aug. 27, 2026

(54) LATENCY OPTIMIZATIONS VIA DEVICE ASSISTED DATA BUFFER MANAGEMENT

(71) Applicant: Rickard LJUNG

(72) Inventor: Rickard LJUNG

(21) Appl. No.: 18/992,184

(22) PCT Filed: Aug. 15, 2022
(86) PCT No.: PCT/IB2022/057628

§ 371 Date: Jan. 8, 2025

(51) Int. Cl. H04W 28/02; H04L 47/2416; H04L 47/263; H04L 47/33

(52) U.S. Cl. CPC H04W 28/0289; H04L 47/2416; H04L 47/263; H04L 47/33

(57) ABSTRACT

A method, system and apparatus are disclosed. A first wireless device (WD) configured to communicate with a network node is described. The network node is configured to communicate with a set of second WDs. The first WD and each WD of the set of second WDs are configurable to perform at least one or more actions to provide a common function. The first WD comprises processing circuitry configured to determine a network configuration for the network node to transmit a notification to the set of second WDs when the first WD experiences a congestion condition. The notification indicates at least one WD of the set of second WDs to perform a compensation action to maintain a seamless continuity of the common function. A radio interface is configured to transmit the determined network configuration to the network node.

### TECHNICAL FIELD

The present disclosure relates to wireless communications, and in particular, to latency optimization of wireless communications.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD) such as user equipment (UE), as well as communication between network nodes and between WDs.

Some applications and services that utilize wireless communication systems demand a predetermined latency (e.g., low latency) and a predetermined data rate (e.g., stable high data rate). For example, some of these applications (and/or services) may include near real time applications such as live video streaming, video production, gaming, virtual reality (VR) and/or extended reality (XR) applications.

The predetermined latency and/or predetermined data rate may be difficult to meet using existing technology and may be higher in applications associated with certain industries. For example, additional demands may be in place in critical industry processes such as processes that involve one or more cameras and artificial intelligence (i.e., camera+AI), e.g., camera+AI driven industry processes management, industry machine surveillance. Such critical industry processes typically demand a predetermined quality of experience (QoE) (e.g., high quality of experience) and/or a predetermined latency (e.g., very low and stable latency) in data transfer.

Historically, many of these applications have used wired connections to meet the predetermined latency and data rate requirements, but for flexibility and efficiency, a wireless connection may be preferred. However, utilizing a wireless network typically results in data being queued up in buffers due to congestions on the path between transmitters and receivers.

An aspect is that multiple devices, e.g., WDs and/or network nodes, are inter-connected to each other and/or part of a combined system. If a network experiences high latency, e.g., due to high network load there may be actions somewhere in the combined system that could be taken to mitigate the issue. For example, in a gaming use case such as VR and/or AR use case where multiple devices are involved within the same use case, a gaming controller may adjust data rate in multiple data source devices. That is, the gaming controller may adapt the creation of application content based on instantaneous capabilities of the wireless network.

Further, some machines or processes may not meet established requirements when predetermined network latencies are exceeded, e.g., processes/machines associated with connected devices such as sensors and controlling units coupled to the machines. For example, an industrial process may require a controlling unit to wirelessly cause an actuator to stop a process within a predetermined time interval, e.g., to respond to an emergency. However, latency of wireless networks may cause the actuator to stop after the predetermined time interval has elapsed, which renders the wireless network unfit for such a use case.

With respect to congestion mitigation measures, Low Latency, Low Loss, Scalable Throughput Internet Service (L4S) has been developed as a network function which can be used to inform a receiver of application data about congestion in the network and similar solutions. The network may add an indicator/flag (Explicit congestion notification—ECN) indicating Congestion Encountered into internet protocol (IP) packet header that indicates to the packet receiver that the network experiences congestion. The application in the receiver side can provide feedback to involved functions, e.g., by setting an ECN Echo flag in acknowledgement traffic to the original packet transmitter for the packet transmitter to take such congestion information into account.

L4S and similar solutions for piggybacking network information onto data transferred to a receiver of user data (e.g., on IP layer) may be usable in some use cases (e.g., sharing useful status information from the network which in turn can utilized by the receiver application for adapting the service). In addition, a receiver node or an intermediate node within the data path may set an ECN echo flag in response traffic to a source node. For example, when using TCP protocol each packet may be acknowledged, where control signaling in the direction of the acknowledgement is already available.

Put differently, there are various technologies for source node notification and receiver node notifications based on attaching information in data packets transferred to them. However, drawbacks exist with the existing solutions e.g., in the flexibility to handle multi-device systems and device-controlled configurability.

Further, strict requirements, which are in place for on-time critical services such as industry process control, demand that the network node (e.g., network) provide information directly (e.g., with shortest possible transmission delay for such feedback) to the most relevant/critical devices. A management unit of a multi-device use case is an example of a relevant and/or critical device. In some cases, providing information directly to the most relevant/critical devices is of higher importance than providing information to a payload data receiver for specific congested packets (once such packets arrive). However, as existing systems have limited flexibility as to where congestion information is sent, existing systems may not be usable where a critical device that is not a receiver/transmitter of payload data needs information to perform a critical function.

In addition, advanced network nodes such as gNBs of wireless communication systems may be available to extract and share additional information relevant to external nodes. However, configuration and selection provided by existing advanced network nodes is limited, especially when related to congestion information that may be shared from the network.

In other words, existing systems lack functions and/or methods for providing network assistance information that may be used by WDs and/or network nodes (other than a receiver/transmitter WD and/or network node) to mitigate network latency and other network conditions.

### SUMMARY

Some embodiments advantageously provide methods, systems, and apparatuses for latency optimizations/determinations via device-assisted data buffer management. In some embodiments, one or more wireless devices (e.g., controlling units) may be receive (e.g., be provided with) real time data (e.g., near real time data, real time information) associated with instantaneous network issues such as when latency exceeds a predetermined threshold (e.g., high latency) and/or other network issues occur. In some other embodiments, one or more mitigation steps may be performed, e.g., when a wireless device and/or network node is unable to provide real time data transfer.

One or more embodiments provide reduction of delays caused within a data communication path. In one embodiment, relevant network information is transmitted to one or more appointed devices (i.e., wireless devices). Such reduced notification time improves quality of experience when compared to quality of experiences provided by existing system such as system that comprise latency critical, near real time applications, gaming applications, virtual reality applications, extended reality applications, industrial applications, etc.

In some embodiments, a first wireless device (WD) is configured to identify one or more other WDs as target receivers of network congestion information. In some other embodiments, the first WD transmits a configuration message to a network node (e.g., a network node in a serving wireless network). The message includes a request for the network node to extract and/or transmit network congestion information to the one or more other WDs. The extraction and/or transmission may be performed upon (or prior to, or after) exceeding predetermined network latency occasions (e.g., when high network latency occasions are determined).

In one embodiment, the wireless network (e.g., one or more WDs, one or more network nodes) is pre-configured with information to enable notifications of network latency issues. The notifications may be sent to any network node and/or WD such as external node(s)/device(s) which may be coupled to an application service associated with the first wireless device.

In another embodiment, upon determining a future (i.e., potential) network latency issue, the network node may use the information from the pre-configuration to determine whether to transmit a notification and/or notify wireless devices such as appointed external device(s). An example of a network latency issue may include a data packet from the first wireless device being queued at a receive-or-transmit buffer of the network node for more than a predetermined interval of time.

In some embodiments, with respect to the configuration process, a WD function such as an application entity (e.g., a software application) within the WD is at least one of a source (transmitter) or a sink (receiver) within a payload data path. The WD (e.g., the WD function) may be configured to contact a network node (e.g., a network function) to set up a network latency information sharing session. This configuration process may provide the network node with relevant information to set up network latency information sharing policies for a software application. Setting up network latency information sharing policies may be based network assistance features available from the network node (e.g., network, WDs) for the software application. In one or more embodiments, latency information may be extracted from internet protocol (IP) packet statistics for packets transmitted to or from the WD, transferred by the wireless network to a receiving node (e.g., another WD) connected to the wireless network.

In some other embodiments, the information may be transferred, e.g., the configured network information is shared with one or more WDs and/or network nodes. The network node may be configured to extract packet transfer information from a data stream (e.g., associated with the first WD and/or other WDs) and/or provide the extracted packet transfer information to one or more network nodes and one or more other WDs (e.g., appointed WDs, application nodes) such as for optimizing a quality of experience for the software application associated with the data stream.

In an embodiment, the type of information shared from the network node to the one or more network nodes and one or more WDs (e.g., appointed devices/nodes) may be dependent on what information is available to the network node (e.g., in the network) and/or what the network node allows (e.g., is configured to allow) to be provided. The type of information may be related to network congestion information such as a low latency low loss scalable throughput (L4S) explicit congestion notification (ECN) indicator bitstream, a packet data queue measurement, a transmission control protocol (TCP) traffic volume indicator, a relative service usage quota level, internet protocol (IP) packet delay statistics or similar for a given data path.

In some embodiments, a WD (and/or network node) may be configured to identify/determine one or more network nodes and/or WDs coupled to (e.g., providing service for, performing one or more actions for) a same software application and/or use case service and/or a common function. The WD (and/or network node) may configure a wireless communication network (e.g., a network node) to extract packet transfer information from a wireless network during payload data transfer involving the WD as payload data transfer transmitter or receiver. The information may be indicative of one or more network congestion parameters such as for determining the current application data transfer capabilities of the wireless network for a specific data transfer.

In some other embodiments, the information is selected to be transmitted by the network node and/or when to transmit the information is determined based on one or more congestion and/or network performance trigger levels. Further, which WDs and/or network node to transmit the information may be determined by the configuration.

One or more embodiments may be advantageous at least because one or more of the following may be provided:
Delay reduction for latency critical services involving multiple WDs and network nodes, e.g., for a communication use case scenario. More specifically, WDs and/or network node can be configured to receive the information (e.g., associated with latency) and/or respond to maintain a seamless continuity of a common function. This enables shorter delays in the signaling of network information, since the network node can be configured to transmit the information immediately upon (or before, or after) delays/congestion in the network are determined. No further latency is caused by requiring the data source or data receiver to transmit or receive any further information.
Flexibility, with maintained privacy. More specifically, multiple WDs and/or network nodes associated with a common function (e.g., coupled within the same use case) may be configured to determine one or more other WDs and/or network nodes to directly receive network congestion information. Also, the network node may share relevant latency information to one or more other WDs and/or network nodes that are external (outside of the wireless network), e.g., without providing payload data information such as IP header information, source or receiving node identities, etc.

In some embodiments, an intermediate network node may detect a high level of congestion for the data communication such as due to a buffer congestion within the network node and thereafter send a packet to the data source comprising a packet congestion indication. A packet generated by an intermediate node may be formed as a packet that appears to originate from the data receiver. Further, the intermediate node upon detecting a congested state may also detect a packet from the data receiver to the data source being a response packet (ACK) of a TCP transmitted by the data receiver. The intermediate node may then rewrite the ECN Echo flag in that packet before sending towards the data source.

According to one aspect, a first wireless device (WD) configured to communicate with a network node is described. The network node is configured to communicate with a set of second WDs. The first WD and each WD of the set of second WDs are configurable to perform at least one or more actions to provide a common function. The first WD includes processing circuitry configured to determine a network configuration for the network node to transmit a notification to the set of second WDs when the first WD experiences a congestion condition. The notification causes at least one WD of the set of second WDs to perform a compensation action to maintain a seamless continuity of the common function. A radio interface in communication with the processing circuitry is configured to transmit the determined network configuration to the network node.

In some embodiments, the network configuration includes data stream information about a data stream associated with the first WD. The data stream information triggers the network node to monitor the data stream to determine that the first WD is experiencing the congestion condition and to transmit the notification to the set of second WDs.

In some other embodiments, the network configuration is transmitted to the network node when a data session setup corresponding to the first WD is completed.

In an embodiment, the network configuration includes at least one identifier of at least one WD of the set of second WDs.

In another embodiment, the network configuration includes at least one trigger for the network node to transmit the notification, where the at least one trigger is based on at least one of a packet latency value associated with at least one packet corresponding to the first WD.

In some embodiments, the network configuration includes a capability indication indicating a plurality of parameters associated with the congestion condition.

In some other embodiments, the notification is transmitted to the set of second WDs, and the compensation action is performed within a predetermined latency range.

In an embodiment, the compensation action includes a reduction of data rate associated with at least one WD of the set of second WDs.

In another embodiment, the at least one or more actions to provide the common function includes sharing data, within a predetermined latency range, between the first WD and at least one WD of the set of second WDs.

In some embodiments, the common function includes one or more of: a process associated with a common software application, the common software application being used by the first WD and at least one WD of the set of second WDs to share data; a video streaming from the first WD and at last one WD of the set of second WDs; and an industrial control function to at least one of control and monitor the first WD and at least one WD of the set of second WDs.

According to another aspect, a method in a first wireless device (WD), configured to communicate with a network node is described. The network node is configured to communicate with a set of second WDs. The first WD and each WD of the set of second WDs are configurable to perform at least one or more actions to provide a common function. The method comprises determining a network configuration for the network node to transmit a notification to the set of second WDs when the first WD experiences a congestion condition. The notification causes at least one WD of the set of second WDs to perform a compensation action to maintain a seamless continuity of the common function. The method further includes transmitting the determined network configuration to the network node.

In some embodiments, the network configuration includes data stream information about a data stream associated with the first WD. The data stream information triggers the network node to monitor the data stream to determine that the first WD is experiencing the congestion condition and to transmit the notification to the set of second WDs.

In some other embodiments, the network configuration is transmitted to the network node when a data session setup corresponding to the first WD is completed.

In an embodiment, the network configuration includes at least one identifier of at least one WD of the set of second WDs.

In another embodiment, the network configuration includes at least one trigger for the network node to transmit the notification. The at least one trigger is based on at least one of a packet latency value associated with at least one packet corresponding to the first WD.

In some embodiments, the network configuration includes a capability indication indicating a plurality of parameters associated with the congestion condition.

In some other embodiment, the notification is transmitted to the set of second WDs and the compensation action is performed within a predetermined latency range.

In an embodiment, the compensation action includes a reduction of data rate associated with at least one WD of the set of second WDs.

In another embodiment, the at least one or more actions to provide the common function includes sharing data, within a predetermined latency range, between the first WD and at least one WD of the set of second WDs.

In some embodiments, the common function includes one or more of: a process associated with a common software application, the common software application being used by the first WD and at least one WD of the set of second WDs to share data; a video streaming from the first WD and at last one WD of the set of second WDs; and an industrial control function to at least one of control and monitor the first WD and at least one WD of the set of second WDs.

According to one aspect, a network node configured to communicate with a first wireless device (WD) and a set of second WDs is descried. The first WD and each WD of the set of second WDs are configurable to perform at least one or more actions to provide a common function. The network node includes a communication interface configured to: receive, from the first WD, a network configuration for the network node to transmit a notification to the set of second WDs when the first WD experiences a congestion condition, the notification causing at least one WD of the set of second WDs to perform a compensation action to maintain a seamless continuity of the common function; and transmit the notification to at least one WD of the set of second WDs. Processing circuitry in communication with the communication interface is configured to determine the notification based on the received network configuration.

In some embodiments, the network configuration includes data stream information about a data stream associated with the first WD, and the processing circuitry is further configured to monitor the data stream and determine that the first WD is experiencing the congestion condition.

In some other embodiments, the network configuration is received by the network node when a data session setup corresponding to the first WD is completed.

In an embodiment, the network configuration includes at least one identifier of at least one WD of the set of second WDs, and the processing circuitry is further configured to determine the at least one WD of the set of second WDs to transmit the notification based on the at least one identifier.

In another embodiment, the network configuration includes at least one trigger for the network node to transmit the notification. The at least one trigger is based on at least one of a packet latency value associated with at least one packet corresponding to the first WD. The processing circuitry is further configured to determine the at least one trigger based on the network configuration and cause the communication interface to transmit the notification based at least one the at least one trigger.

In some embodiments, the network configuration includes a capability indication indicating a plurality of parameters associated with the congestion condition. The processing circuitry is further configured to determine the plurality of parameters associated with the congestion condition and cause the communication interface to transmit the plurality of parameters to at least one WD of the set of second WDs.

In some other embodiments, the notification is transmitted to the set of second WDs and the compensation action is performed within a predetermined latency range.

In one embodiment, the compensation action includes a reduction of data rate associated with at least one WD of the set of second WDs.

In another embodiment, the at least one or more actions to provide the common function includes sharing data, within a predetermined latency range, between the first WD and at least one WD of the set of second WDs.

In some embodiments, the common function includes one or more of: a process associated with a common software application, the common software application being used by the first WD and at least one WD of the set of second WDs to share data; a video streaming from the first WD and at last one WD of the set of second WDs; and an industrial control function to at least one of control and monitor the first WD and at least one WD of the set of second WDs.

According to another aspect, a method in a network node configured to communicate with a first wireless device (WD) and a set of second WDs is described. The first WD and each WD of the set of second WDs are configurable to perform at least one or more actions to provide a common function. The method includes receiving, from the first WD, a network configuration for the network node to transmit a notification to the set of second WDs when the first WD experiences a congestion condition. The notification causes at least one WD of the set of second WDs to perform a compensation action to maintain a seamless continuity of the common function. The method further includes determining the notification based on the received network configuration and transmitting the notification to at least one WD of the set of second WDs.

In some embodiments, the network configuration includes data stream information about a data stream associated with the first WD. The method further includes monitoring the data stream; and determining that the first WD is experiencing the congestion condition.

In some other embodiments, the network configuration is received by the network node when a data session setup corresponding to the first WD is completed.

In an embodiment, the network configuration includes at least one identifier of at least one WD of the set of second WDs. The method further includes determining the at least one WD of the set of second WDs to transmit the notification based on the at least one identifier.

In another embodiment, the network configuration includes at least one trigger for the network node to transmit the notification. The at least one trigger is based on at least one of a packet latency value associated with at least one packet corresponding to the first WD. The method further includes determining the at least one trigger based on the network configuration and transmitting the notification based at least one the at least one trigger.

In some embodiments, the network configuration includes a capability indication indicating a plurality of parameters associated with the congestion condition. The method further includes determining the plurality of parameters associated with the congestion condition and transmitting the plurality of parameters to at least one WD of the set of second WDs.

In some other embodiments, the notification is transmitted to the set of second WDs and the compensation action is performed within a predetermined latency range.

In an embodiment, the compensation action includes a reduction of data rate associated with at least one WD of the set of second WDs.

In another embodiment, the at least one or more actions to provide the common function includes sharing data, within a predetermined latency range, between the first WD and at least one WD of the set of second WDs.

In some embodiments, the common function includes one or more of: a process associated with a common software application, the common software application being used by the first WD and at least one WD of the set of second WDs to share data; a video streaming from the first WD and at last one WD of the set of second WDs; and an industrial control function to at least one of control and monitor the first WD and at least one WD of the set of second WDs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a WD according to some embodiments of the present disclosure;

FIG. 8 is a flowchart of an example process in a network node according to some embodiments of the present disclosure;

FIG. 9 shows an example network architecture including at least a WD such as controller device according to some embodiments of the present disclosure;

FIG. 10 shows another example network architecture including at least a WD such as a source device experiencing a latency condition according to some embodiments of the present disclosure;

FIG. 11 shows an example network architecture including at least a WD such as a source device providing a latency indication according to some embodiments of the present disclosure; and

FIG. 12 shows another example network architecture including at least a WD such as a controller device receiving a latency indication according to some embodiments of the present disclosure;

FIG. 13 an example inter-connection between devices such as WDs and an application server according to some embodiments of the present disclosure;

FIG. 14 shows another example network architecture associated with a video production according to some embodiments of the present disclosure;

FIG. 15 shows a block diagram of example packet including at least a packet performance unit connection according to some embodiments of the present disclosure; and

FIG. 16 is a flowchart of another example process according to some embodiments of the present disclosure.

### DETAILED DESCRIPTION

Before describing in detail example embodiments, it is noted that the embodiments reside primarily in combinations of apparatus components and processing steps related to latency optimizations/determinations via device-assisted data buffer management. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), application server, data receiver/transmitter, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, source device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, a camera, a camera controller management function (CCMF) such as a local CCMF (LCCMF), a controller device, a service controller such as a master service controller, controller management function, etc. In some embodiments, controller device may refer to a service controller.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), local area networks such as based on IEEE 802.11 standards may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, a common function may refer to a function that is shared by one or more WDs and/or network nodes and/or any other device. A common function may include performing, by the one or more WDs and/or network nodes, one or more steps for the common function and/or to achieve a goal of the common function. In a nonlimiting example a common function may comprise a process associated with a common software application. The common software application may be used by one or more WDs and/or network node such as to share data and/or information and/or signaling. Further, a common function may include a video streaming from one WD to one or more other WDs of a set of other WDs. A common function may also be an industrial control function to at least one of control and/or monitor one or more WDs and/or network nodes.

In some other embodiments, the term compensation action may refer to any action (e.g., performed by a WD, network node, etc.). The compensation action may be associated with a common function, e.g., where an action is performed to support the common function such as to provide a seamless continuity of the common function. For example, the compensation action may include a reduction of data rate, e.g., in response to a notification of a latency condition. However, a reduction of data rate is one non-limiting example of a compensation action (e.g., which the WD may perform upon receiving the notification). Several types of compensation actions may be suitable (e.g., performed) and/or may depend on the use case and/or the level of congestion (i.e., a severity of the congestion indicated to the WD). Other examples of compensation actions may include, without being limited to, transmitting data flow modification requests such as for the use case of the connected devices (e.g., requesting data to be transmitted to or from other devices in the network), requesting different network nodes to manage the data, requesting to the network e.g., network node) different quality of service level to be applied to the data, to limit the communication such as within the use case as a reaction to the congestion notification. Further, compensation actions (and/or other actions associated with the compensation actions) may also include stopping one or more data communication flows.

In an embodiment, a set may refer to an open set (i.e., including one element). The set may refer to another set such as including two or more elements. For example, a set of WDs may refer to an open set (i.e., including one WD). The set of WDs may refer to another set such as including two or more WDs. Similarly, a set of network nodes may refer to an open set (i.e., including one network node). The set of network nodes may refer to another set such as including two or more network nodes.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

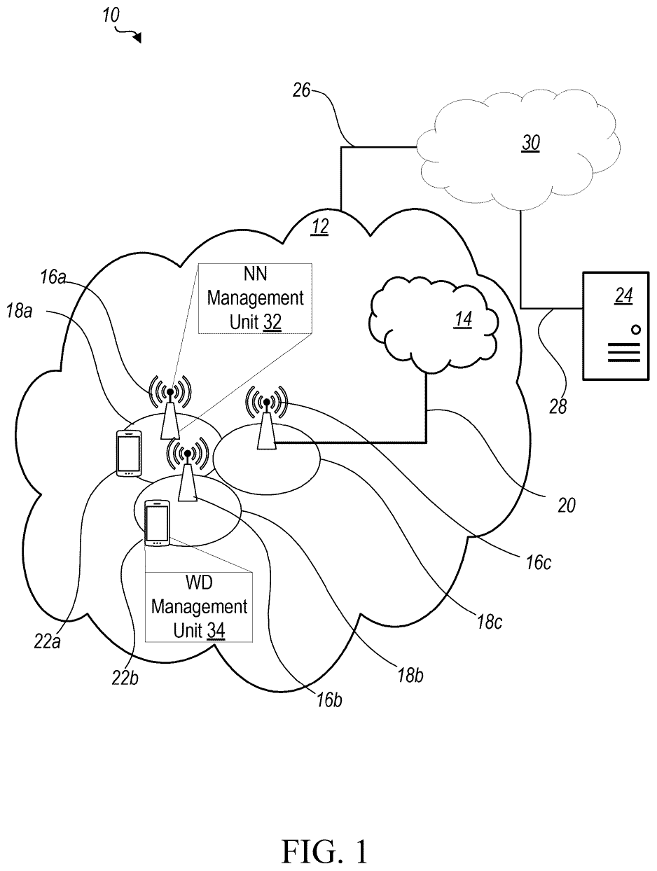

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., determine the notification based on the received network configuration. A wireless device 22 is configured to include a WD management unit 34 which is configured to perform any step and/or task and/or process and/or method and/or feature described in the present disclosure, e.g., determine a network configuration for the network node 16 to transmit a notification to a set of second WDs 22 when a first WD experiences a congestion condition, the notification causing at least one WD 22 of the set of second WDs 22 to perform a compensation action to maintain a seamless continuity of the common function.

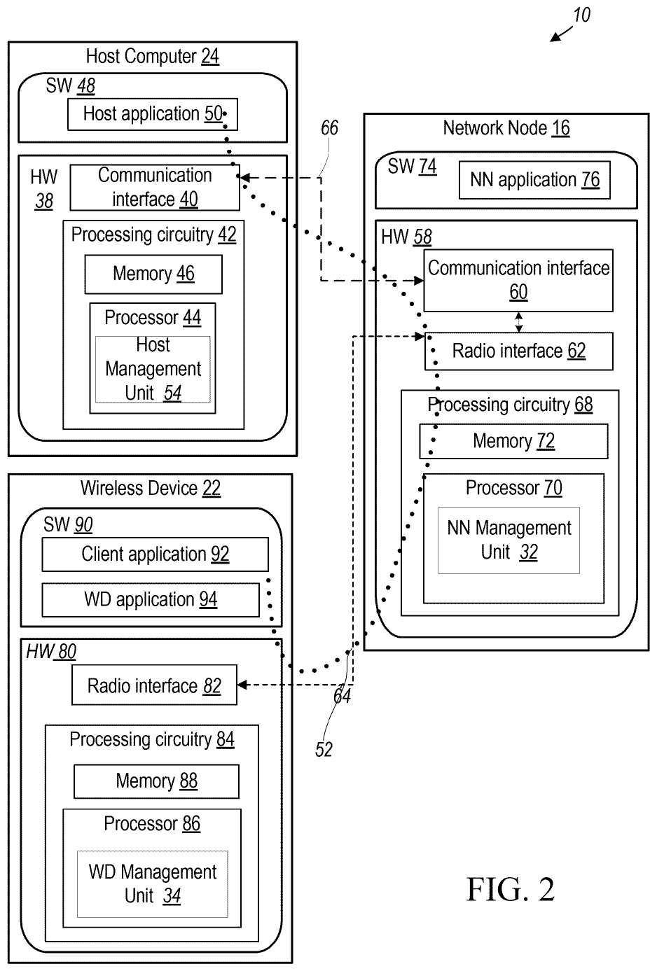

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. Software 74 may include a network node (NN) application 76. NN application 76 may be a software application and may be operable to provide a service/interface to a human or non-human user via the network node 16. Further, NN application 76 may be configured to perform one or more steps associated with a common function (e.g., a function that may be shared with another element/device of communication system 10 such as a WD 22, host computer 24, another network node 16). The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 which is configured to perform any step and/or task and/or process and/or method and/or feature described in the present disclosure, e.g., determine the notification based on the received network configuration.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides. Software 90 may also include a WD application 94. WD application 94 may be a software application and may be operable to provide a service/interface to a human or non-human user via the WD 22. Further, WD application 94 may be configured to perform one or more steps associated with a common function (e.g., a function that may be shared with another element/device of communication system 10 such as a another WD 22, host computer 24, network node 16).

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or task and/or process and/or method and/or feature described in the present disclosure, e.g., determine a network configuration for the network node 16 to transmit a notification to a set of second WDs 22 when a first WD experiences a congestion condition, the notification causing at least one WD 22 of the set of second WDs 22 to perform a compensation action to maintain a seamless continuity of the common function.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

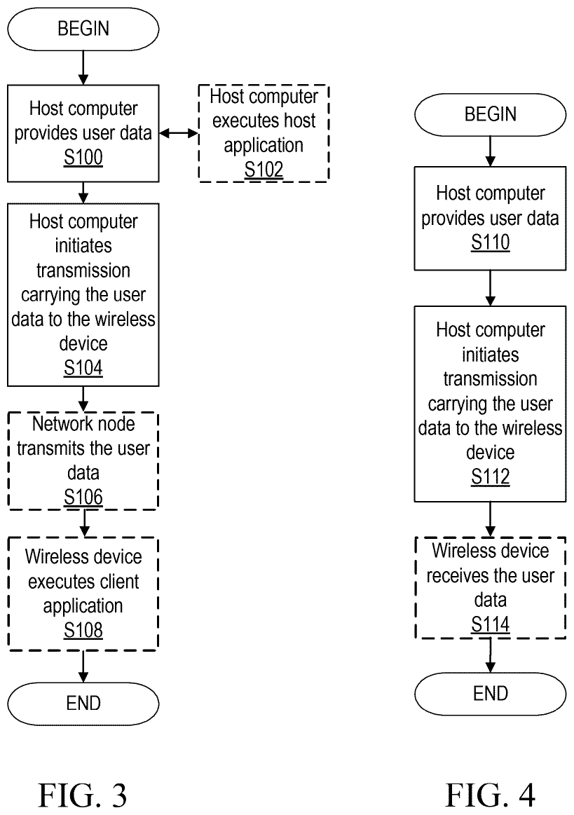

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

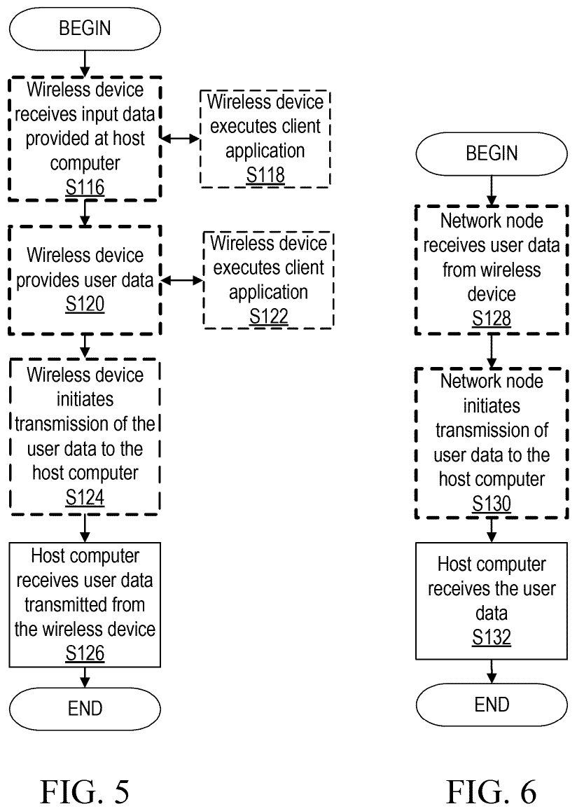

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

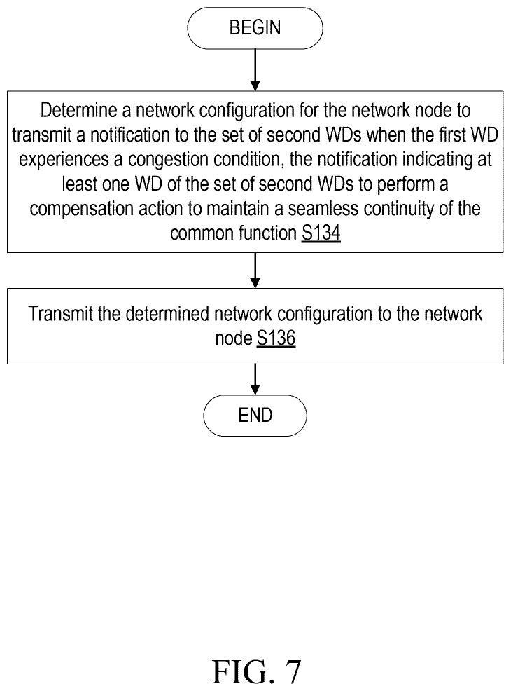

FIG. 7 is a flowchart of an example process in a wireless device 22 according to some embodiments of the present. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to determine (Block S134) a network configuration for the network node to transmit a notification to the set of second WDs 22 when the first WD 22a experiences a congestion condition. The notification causes at least one WD 22 of the set of second WDs 22 to perform a compensation action to maintain a seamless continuity of the common function. The method further includes transmitting (Block S136) the determined network configuration to the network node 16.

In some embodiments, the network configuration includes data stream information about a data stream associated with the first WD 22a. The data stream information triggers the network node to monitor the data stream to determine that the first WD 22a is experiencing the congestion condition and to transmit the notification to the set of second WDs 22.

In some other embodiments, the network configuration is transmitted to the network node 16 when a data session setup corresponding to the first WD 22a is completed.

In an embodiment, the network configuration includes at least one identifier of at least one WD 22 of the set of second WDs 22.

In another embodiment, the network configuration includes at least one trigger for the network node to transmit the notification. The at least one trigger is based on at least one of a packet latency value associated with at least one packet corresponding to the first WD 22a.

In some embodiments, the network configuration includes a capability indication indicating a plurality of parameters associated with the congestion condition.

In some other embodiment, the notification is transmitted to the set of second WDs 22 and the compensation action is performed within a predetermined latency range.

In an embodiment, the compensation action includes a reduction of data rate associated with at least one WD 22 of the set of second WDs 22

In another embodiment, the at least one or more actions to provide the common function includes sharing data, within a predetermined latency range, between the first WD 22a and at least one WD 22 of the set of second WDs 22.

In some embodiments, the common function includes one or more of: a process associated with a common software application, the common software application being used by the first WD 22a and at least one WD 22 of the set of second WDs 22 to share data; a video streaming from the first WD 22a and at last one WD 22 of the set of second WDs 22; and an industrial control function to at least one of control and monitor the first WD 22a and at least one WD 22 of the set of second WDs 22.

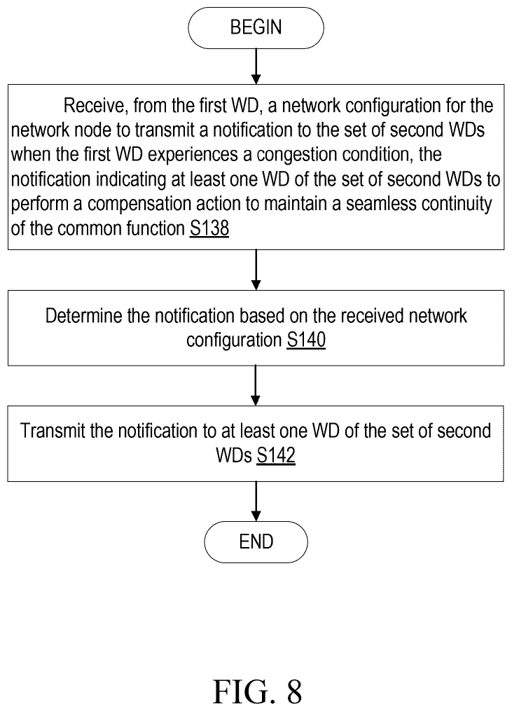

FIG. 8 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to receive (Block S138), from the first WD 22a, a network configuration for the network node to transmit a notification to the set of second WDs 22 when the first WD 22a experiences a congestion condition. The notification causes at least one WD 22 of the set of second WDs 22 to perform a compensation action to maintain a seamless continuity of the common function. The method further includes determining (Block S140) the notification based on the received network configuration and transmitting (Block S142) the notification to at least one WD 22 of the set of second WDs 22.

In some embodiments, the network configuration includes data stream information about a data stream associated with the first WD 22a. The method further includes monitoring the data stream; and determining that the first WD 22a is experiencing the congestion condition.

In some other embodiments, the network configuration is received by the network node 16 when a data session setup corresponding to the first WD 22a is completed.

In an embodiment, the network configuration includes at least one identifier of at least one WD 22 of the set of second WDs 22. The method further includes determining the at least one WD 22 of the set of second WDs 22 to transmit the notification based on the at least one identifier.

In another embodiment, the network configuration includes at least one trigger for the network node to transmit the notification. The at least one trigger is based on at least one of a packet latency value associated with at least one packet corresponding to the first WD 22a. The method further includes determining the at least one trigger based on the network configuration and transmitting the notification based at least one the at least one trigger.

In some embodiments, the network configuration includes a capability indication indicating a plurality of parameters associated with the congestion condition. The method further includes determining the plurality of parameters associated with the congestion condition and transmitting the plurality of parameters to at least one WD 22 of the set of second WDs 22.

In some other embodiments, the notification is transmitted to the set of second WDs 22 and the compensation action is performed within a predetermined latency range.

In an embodiment, the compensation action includes a reduction of data rate associated with at least one WD 22 of the set of second WDs 22.

In another embodiment, the at least one or more actions to provide the common function includes sharing data, within a predetermined latency range, between the first WD 22a and at least one WD 22 of the set of second WDs 22.

In some embodiments, the common function includes one or more of: a process associated with a common software application, the common software application being used by the first WD 22a and at least one WD 22 of the set of second WDs 22 to share data; a video streaming from the first WD 22a and at last one WD 22 of the set of second WDs 22; and an industrial control function to at least one of control and monitor the first WD 22a and at least one WD 22 of the set of second WDs 22.

Having described the general process flow of arrangements of the disclosure and having provided examples of hardware and software arrangements for implementing the processes and functions of the disclosure, the sections below provide details and examples of arrangements for latency optimizations and/or determinations via device-assisted data buffer management.

### System Overview

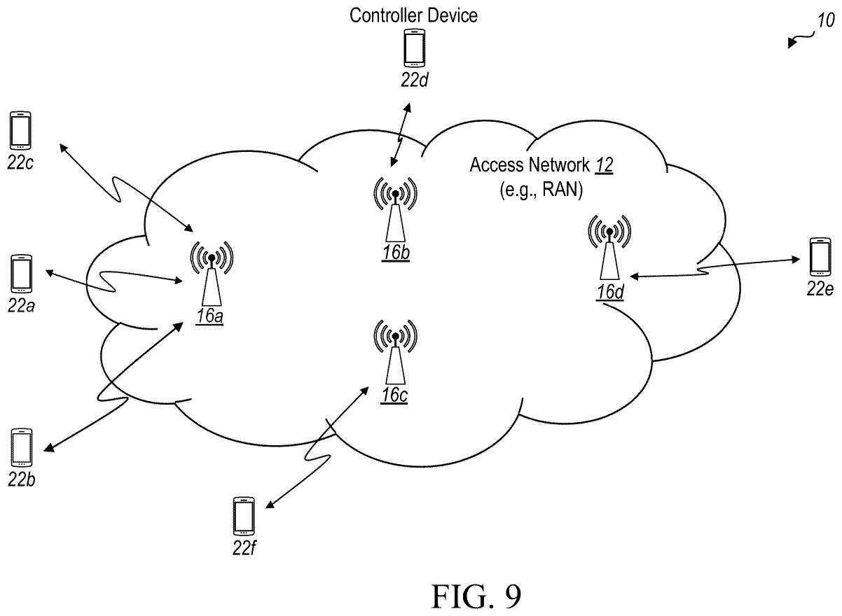

FIG. 9 shows an example network architecture of communication system 10 including at least a WD 22 such as controller device. Communication system may include access network 12 (e.g., a RAN, wireless network), one or more network nodes 16 (e.g., network nodes 16a, 16b, 16c, 16d), and/or one or more WDs 22 (e.g., WDs 22a, 22b, 22c, 22d, 22e). Each one of the WDs 22 may be configured as a controller device (e.g., a master service controller), which may be configured to receive information from the network node 16 associated with a network condition (e.g., a latency issue) and/or perform one or more actions based on the received information. One or more WDs 22 may be configured to perform one or more other actions associated with a common function (e.g., to maintain a seamless continuity of the common function).

A set of WDs (e.g., one or more of WDs 22a, 22b, 22c, 22d, 22e) may be configured to be connected to an access network 12 (e.g., wireless network). One or more WDs 22 of the set of WDs may be configured to perform steps associated with a common function. For example, two or more WDs 22 may be coupled together (e.g., connected at least to a common entity, network, network node, software application, application server, and/or performing steps of the common function) such as by being included in the same use case and/or application (e.g., software application). In some embodiments, coupled together refers to at least one of the WDs 22 having inter-dependencies between each other by being part of a use case and/or application, sharing information (e.g., associated with the common function), using the shared information, performing at least one action based on the shared information. In some other embodiments, the WDs 22 are inter-connected. In some other embodiments, access network 12 is a latency critical network and/or the common function refers to a time critical service. In one embodiment, access network 12 and/or network nodes 16 and/or WDs 22 are configurable to support an industry/industrial process (e.g., as a use case). In another embodiment, access network 12 and/or network nodes 16 and/or WDs 22 are configurable to support a video production process (e.g., as another use case).

The following are some nonlimiting examples of inter-connected WDs and/or how communication system 10 (and/or any of its components) may perform (or not perform) one or more actions in response to a network latency condition.
In one non limiting example, one or more WDs 22 and/or network nodes 16 may be involved in one or more actions associated with a same wireless video production studio, such as to support video production. One or more WDs may be video cameras connectable/connected such as directly and/or via access network 12. One or more WDs 22 may be configured to act ss a local video production unit, where video (and/or audio) production decisions are made. Further, one or more WDs 22 may be a video data sink to which other WDs 22 (e.g., cameras) are sending data (e.g., individual data). The latency of each communication link (e.g., wireless connections 52, 64, 66) may be important, e.g., a live production typically needs to operate with very short jitter buffers. A user requirement of a video production user (e.g., in a control unit) may include that a RAN delay cannot exceeds 100 ms (e.g., otherwise, the service is “destroyed”, or services requirements cannot be met). The RAN delay may be experienced when a source WD 22 such as a camera cannot provide video (or a portion of the video) within the RAN delay. Where the user requirement cannot be met, the source WD 22 may be adjusted to (changed to) another source WD 22 such as another video camera, e.g., to eliminate the source problem. Changing to another source WD 22 may be help mitigate any quality issues for the end production.
In another non limiting example (e.g., a wirelessly connected industry and/or industrial complex), one or more WDs 22 and/or network nodes 16 may be involved in (e.g., configured for) measuring, sensing, and/or controlling a set of machinery (e.g., a set of WDs 22). A low latency network (e.g., access network 12) may be configured to support communication and meet very low latency system requirements, e.g., a predetermined source-to-receiver latency such as a predetermined quantity of milliseconds. Further, a user such as an industrial engineer may realize that a RAN delay that exceeds a predetermined latency threshold such as 100 ms may force a temporary halt of one or more components of communication system 10 such as one or more WDs 22 (e.g., a remotely managed/controlled machine). The halt may be performed to prevent any damages such as damages resulting from a machine that cannot be monitored/controlled when the RAN delay is exceeded. Where the low latency system requirements cannot be met, one or more machines (e.g., WDs 22) may have one or more other WDs 22 (e.g., controlling units) that can be configured to perform one or more actions if any a sensor and/or other input device is no longer communicating (and/or meeting the low latency system requirements). The one or more actions may include reconnecting to the remotely managed/controlled machine to re-establish communication within the RAN delay requirement.

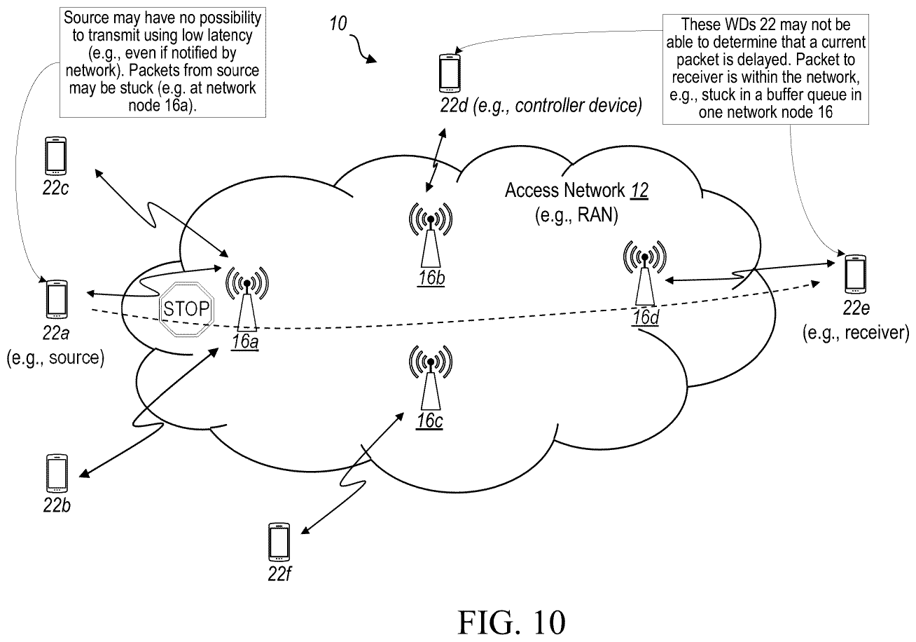

FIG. 10 shows another example network architecture including at least a WD 22 such as a source device experiencing a latency condition. In other words, one or more WDs 22 (e.g., WD 22 such as source) may be configured to transmit information/data such as latency critical information/data to one or more other WDs 22 (e.g., WD 22e such as a receiver). However, access network 12 may experience a latency that exceeds a predetermined latency threshold such as a high latency. The latency may be experienced with and/or caused by a network node 16 (e.g., a gNB) connected to WD 22a (e.g., transmitting wireless device). The delay of the information/data (e.g., packets) may be significant for a service, such as that one or more of functions of the service cannot be performed within the latency threshold.

In addition, there may be no opportunity for WDs 22 and/or network nodes 16 to be aware of it in time and to mitigate the situation (e.g., unless one or more WDs 22 and/or network nodes 16 are notified to perform one or more actions). For example, as long as the packet is stuck within the access network 12, e.g., in a buffer such as memory 72 of network node 16 (e.g., gNB), WD 22e (e.g., the receiver) may not be aware of the packet not being able to traverse the network node 16, or know a current level of congestion in the access network 12. WD 22a (e.g., source) may not be able transmit anything (as packets are getting trapped in the network) and may not be able to send any alarm signal to any other device. A WD 22 such as WD 22d acting as controller device associated with to the same use of WD 22a may not be able to act (e.g., unless notified) as WD 22e does not have any information about the recent latency condition/congestion.

In other words, as shown in FIG. 10, sometimes a latency condition may occur such as where a critical load condition in a network node 16 (e.g., RAN node) or other event causing a predetermined RAN latency (e.g., high latency) for source WD transmissions. A packet from WD 22 (e.g., source) may have spent 50 ms in buffer of a network node 16 (e.g., gNB) within the RAN, where congestion has occurred.

Neither of the intended packet receiver (i.e., WD 22e) nor the controller device (e.g., WD 22d) is aware of the packet issue.

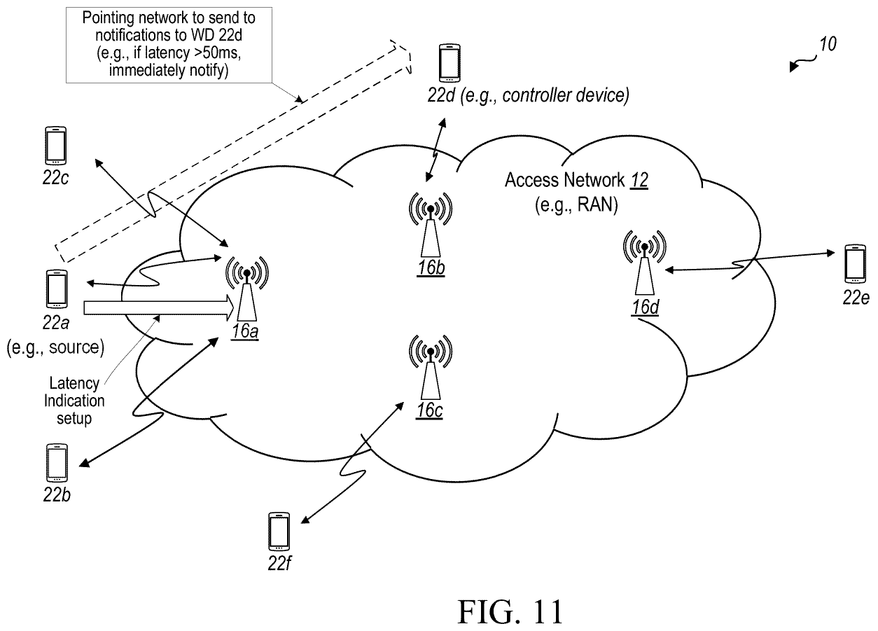

FIG. 11 shows an example network architecture including at least a WD such as a source device providing a latency indication (e.g., one solution to one or more conditions described in FIGS. 9 and 10). At least one WD 22 such as WD 22a (e.g., source) may configure the network such as a network node 16. The configuration may be triggered by one or more conditions such as upon a data session setup. The configuration may be performed to assist network latency by providing information to one or more WDs 22 and/or network nodes 16. The provided information may refer to notification information. At least one of the following may be performed:
WD 22 (e.g., WD 22a) may indicate (e.g., to network node 16), such as part of a network configuration, which data stream to monitor and share network latency/congestion information on. This may be indicated by sharing one or more transmit or receive internet protocol (IP) addresses or any other type of identifier associated with another WD 22 and/or network node 16 (such as a data communication node).
WD 22 (e.g., WD 22a) may indicate (e.g., to network node 16), such as part of a network configuration, one or more addresses to WDs 22 and/or network nodes 16 that are to be notified upon a network condition occurring such as a network congestion. In this example, WD 22a points to (e.g., indicates the address of) WD 22d (e.g., the controller device), which may receive one or more notifications associated with the network condition (e.g., a network latency exceeding 50 ms). As one example such address may be an IP address. In other words, the address/addresses may be pointers to where the network nodes 16 may transmit one or more notifications (e.g., latency notifications) when a network congestion such as a potential/future network congestion is determined (e.g., by a WD 22, network node 16).
WD 22 (e.g., WD 22a) may indicate (e.g., to network node 16) one or more triggers, e.g., such as part of a network configuration. The one or more triggers may be used to determine when to send such notifications (latency notifications). One or more triggers may be indicative of a packet latency time value. For example, a WD 22 (e.g., WD 22a) may be configured to request a network node 16 to transmit the latency notification to the one or more WDs 22 where each WD 22 has a predetermined address. The latency notification may be transmitted if a packet latency of a packet is larger than a predetermined value. Such predetermined value may be in ms, e.g., 10 ms, 50 ms or 100 ms. Other triggers may be associated with multiple packets. For example, if multiple packets have been delayed more than a predetermined value, a notification may be transmitted to one or more other WDs 22. The notification may be transmitted, e.g., if two or more packets within a period of 100 ms have been delayed more than 10 ms each. The network configuration may also include one or more timer values or other trigger that may trigger a network node 16 and/or a WD 22 to stop of the information sharing on a data link, e.g., after no packet has been transferred on the communication link for a predetermined time interval.
WD 22 (e.g., WD 22a) may indicate (e.g., to network node 16) one or more triggers, e.g., such as part of a network configuration, which type of information a network node 16 (e.g., comprising a network function) may provide to the one or more WDs 22 and/or network nodes 16 (e.g., that have a predetermined address) when any of the triggers occur. The network configuration may include multiple signaling messages (and/or information about signaling messages), e.g., including a capability indication signaling by a network node 16 (e.g., the network function) to a WD 22. The capability indication may be indicative of which parameters (and/or information) are available for sharing in the network (e.g., with network node 16, WDs 22). Further, another indication may be provided by the WD 22 (e.g., WD 22a), such as part of the network configuration, to the network node 16 (e.g., the network function) and may be indicative of which parameters (and/or information) are to be used/shared. The available parameters (and/or information) may include one or more types of information indicative of congestion level for the network such as, L4S (ECN) indicator bitstream, a packet data queue measurement, a TCP traffic volume indicator, a relative service usage quota level, IP packet delay statistics, etc. In addition, network node 16 may be configured to expose different parameter available to different WDs 22 and/or network nodes 16, e.g., based on an identifier of the WD 22 requesting the information, the IP address of the WD 22, a subscription information available related to the WD 22, an application identity of a WD 22, the type of WD 22, etc. In other words, network node 16 (e.g., the network function) may expose different capabilities of information to different WDs 22 and/or other network nodes 16.

In one nonlimiting example, WD 22a may configure network node 16a to issue a notification (e.g., transmit a notification such as via network node 16b) to WD 22d (e.g., controller device) as soon as any packet is delayed 50 ms or more. Taking additional signaling delay into account the trigger value (i.e., 50 ms) would give any WD 22 acting as controlling node sufficient time to react (e.g., perform one or more actions) before a RAN delay causes more than a critical 100 ms latency. Further updates to the configuration may be made during a data transfer session.

In some embodiments, a solution to the network conditions described in FIGS. 9 and 10 may include, at service setup, WD 22a (e.g., source) and/or other WD 22 connect to a network node 16 (e.g., network function) to configure a latency indication feature. The latency indication feature may include:
Information about where to send notification(s), which may be two or more addresses;
Information about when to send the notification(s): trigger conditions in the network; and/or
Additional information to be included in the notification.

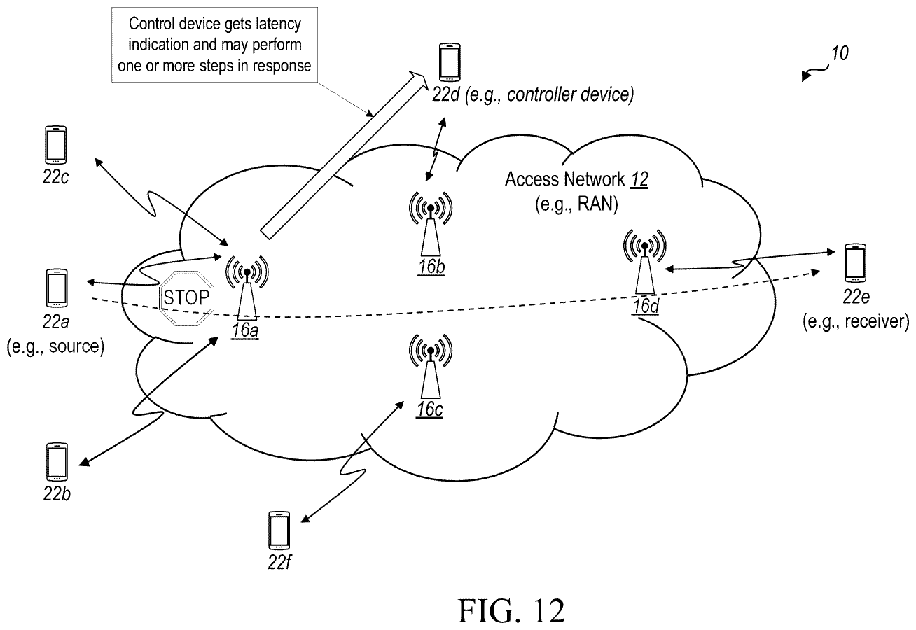

FIG. 12 is another example network architecture including at least a WD 22 (e.g., a controller device) receiving a latency indication, such as part of a network configuration received as shown in FIG. 11. In other words, FIG. 12 shows latency issues/variations being mitigated/handled in a network (access network 12) that supports time critical services. FIG. 12 may be similar to FIG. 10, where WD 22a (e.g., source) cannot communicate within the required communication latency since packets from WD 22a are temporarily queued in network node buffer (e.g., gNB buffer) causing network delays. However, in FIG. 12, one or more network nodes 16 and WDs 22 have been configured to perform one or more action such as based on determined trigger. A network node 16 (e.g., performing a latency indication function) may initiate an indication activity upon determining a packet latency of 50 ms or more has occurred. Network node 16 may issue/determine a notification to be transmitted to another WD 22 such as WD 22d which may be a predetermined controlling node. The controlling node may be informed immediately and/or perform one or more actions in response to the network condition (e.g., network issue). The performed one or more actions may depend on one or more use cases.

In a nonlimiting example, WD 22d (e.g., controller device) may switch a camera source to mitigate any video production problems before the 100 ms latency occurs. In another nonlimiting example, WD 22d (e.g., controller device) machine operation may be halted or switched to be monitored/controlled by another WD 22 before the 100 ms latency occurs.

Further, information sharing may be finalized upon transmitting a command to stop network information sharing and/or or upon an expiration of a timer set during configuration. A controller device can handle the situation before the service quality level of RAN delay of 100 ms has expired.

In some embodiments, upon congestion trigger occurring, network node 16 transmits a notification to an appointed address (e.g., of WD 22d) about the congestion information. WD 22d may receive the notification after 50 ms plus a link latency, e.g., at ~60 ms after source packet transmission. 60 ms may be sufficient for WD 22d to perform one or more actions.

### Aspects of Identifying and/or Finding a Network Node Prior to Configuration

One method to implement the network function, such as comprised in and/or performed by a network node 16, is to introduce a logical entity within a wireless network such as associated with communication system 10. The logical entity is shown as a “packet performance unit” (PPU). The PPU may be comprised in (and configured to perform one or more steps performed by NN management unit 32). In some embodiments, PPU may be referred to as NN management unit 32 (and/or WD management unit 34 and/or host management unit 54). The network function may be implemented as a separate function in a network, or as an integrated function within a network node 16 (and/or WD 22) of communication system 10. In a nonlimiting example, such network functionality may be implemented as part of software such as software 48, 74, 90 (such as an application entity) which may include one or more software applications such as host application 50, NN application 76, client application 92, WD application 94. In another nonlimiting example, the network functionality is implemented as base station software.

The network function may be requested to be activated by an external node which may be a WD 22 and/or network node 16. The WD 22 may be a wireless device acting as a payload packet transmitter or packet receiver. Network node 16 may be a server on the internet or similar. This external node (e.g., an external WD 22) may locate NN management unit 32 (e.g., the PPU network function of a PPU) in different ways. Some examples may include:
A WD 22 (and/or a network node 16) such as an initiating node may use a known, common web address. A wireless network domain name server (DNS) function points the WD 22 to NN management unit 32 (e.g., PPU). Hence, the communication between WD 22 and NN management unit 32 (e.g., PPU) is made via radio interface 62, 82 on IP traffic, e.g., using hypertext transfer protocol (HTTP) protocol.
Network node 16 may be configured to provide information to the WD 22 involved in the payload data transfer. The information may include information about how to reach the NN management unit 32 (e.g., PPU) of the network node 16. This could be provided within one of the communication protocols used for network modem communication, e.g., as a signaling information message on 3GPP radio resource control (RRC) layer or similar.

In one or more nonlimiting examples, the network may support multiple network nodes 16 with PPU functionality. In such case, a network node 16 may respond to a WD-initiated request with one or more alternative PPU types. Such PPU types may include network nodes 16 including (and/or configured to perform steps associated with) a core network PPU, a gNB PPU, an edge PPU, or similar. Network node 16 may provide available geographical locations for different PPUs within the network. The requesting WD 22 may respond to the information about multiple network nodes 16 comprising at least a PPU by contacting at least one of the multiple network nodes 16, such for a configuration as described below.

### Device Interactions—Identification of Inter-Connected Devices

An aspect of the present disclosure is inter-device connections. It is assumed that multiple devices such as WDs 22 and/or network nodes 16 may be related to each other such as to provide a common function. Providing a common function may include executing a common application and/or being part of a same use case, such as supporting the same video production, being connected within the same industry/factory or similar, etc. One or more embodiments are beneficial at least because WDs 22 (and/or network nodes 16) may receive latency information from the network in order to mitigate any issues within the latency critical service running over the network. WDs 22 (and/or network nodes 16) may be configured an address (e.g., IP address) as unique identifier. Network notifications (e.g., such as provided by a network node 16 that may be configured to provide a network notification function) is a pointer to one or more WDs 22 that are to receive network latency notifications.

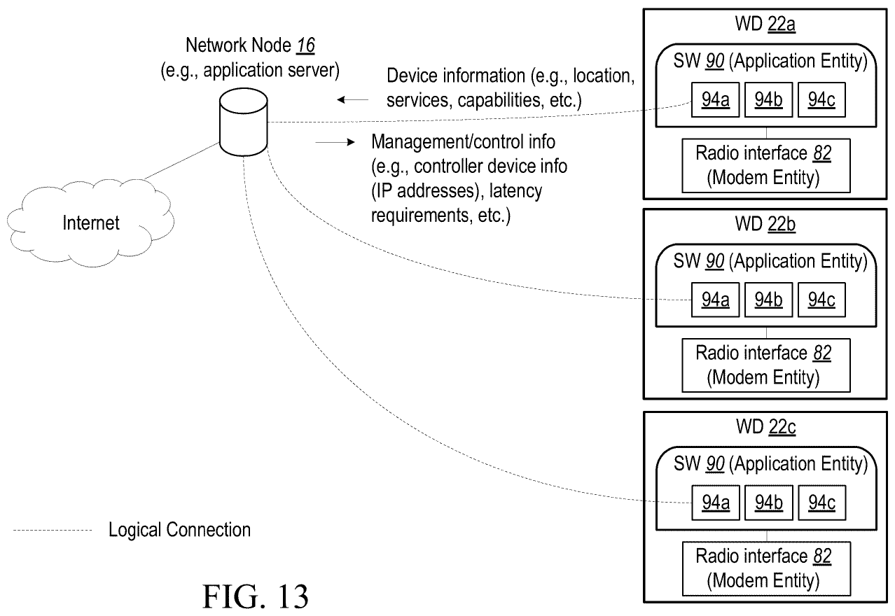

FIG. 13 a diagram showing an example inter-connection between devices such as WDs 22 and a network node 16 such as an application server. More specifically, FIG. 13 shows how inter-connections can be implemented in WDs 22 and/or network nodes 16. WDs 22 (and/or network nodes 16) may be configured to collect information about suitable WDs 22 (e.g., target device(s)) for the latency notifications. In some embodiments, a WD application 94 in a WD 22 may be interacting with network node 16 (e.g., an application server). The application server is not limited to being comprised in a network node 16 and may be comprised in another WD 22. Network node 16 (e.g., an application server) may be configured to be connected to the internet and/or collect information about each WD 22 and/or keep up to date information about WDs 22 that may be suitable controller devices (e.g., based on a use case, latency requirements, etc.). Network node 16 (e.g., an application server) may be configured to provide information to WDs 22, e.g., in order for the network configuration to be managed.

In some other embodiments, network node 16 (e.g., application server) may be a local available device acting as a server available for local communication such as a wireless device capable of inter-device communication such as via an Institute of Electrical and Electronics Engineers (IEEE) 802.11 wireless local access network (LAN), device-to-device communication such as 3GPP sidelink, available over a wireless communication network.

In an embodiment, network node 16 (e.g., application server) may be used as a device information collector to which each device involved in the same use case scenario connects to when connecting to the network. The application server functionality may be use case specific. In another embodiment, network node 16 (e.g., application server) may collect information about IP addresses of the WDs 22, capabilities and/or roles of the WDs 22 in the use case. In some embodiments, network node 16 (e.g., application server) may be configured to provide the required inter-device awareness. In other words, network node 16 (e.g., application server) may provide required information for WDs to be able to perform one or more steps described in the present disclosure. The communication to and from network node 16 (e.g., application server) may be performed as IP traffic, e.g., using HTTP protocol, or similar.

### Illustration Using the Video Production Example

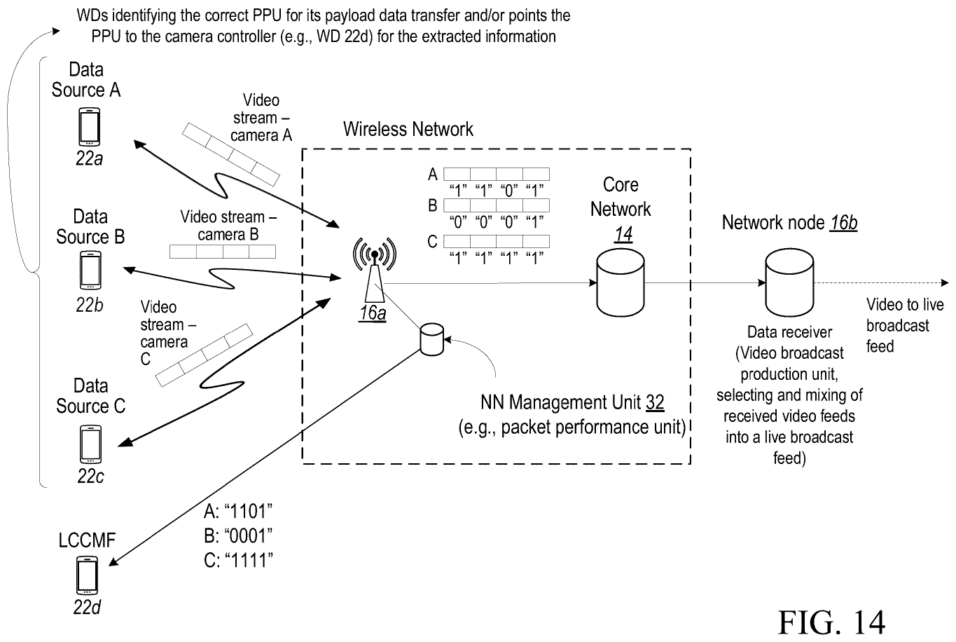

FIG. 14 shows another example network architecture associated with a video production. An indication of network latency may be applied to a video production process, where the production of video streams is locally managed by a WD 22 (e.g., comprising “controller management function”). The WD 22 comprising the central controller management function may directly receive information for determining one or more actions based on the received information, such as from network node 16 (e.g., comprising a PPU).

In one nonlimiting example, upon receiving congestion information from the network node 16 (e.g., PPU), WD 22d (e.g., comprising the controller management function) may determine to reduce data rate from multiple WDs 22a, 22b, 22c (e.g., cameras in the production) to save bandwidth and/or avoid production quality of experience (QoE) issues. WD 22d may not (e.g., may not necessarily be willing necessarily be willing to) reduce the quality from a WD 22 (e.g., camera) with the first notified congestion, since multiple data sources are used for the same use case and one of the WDs 22 (e.g., cameras) supports the current live video stream. WD 22d (e.g., controller management function) may be configured to (e.g., immediately) perform one or more actions on multiple other radio links. In other words, information flow may be configured to optimize one or more use cases such as video production. One or more embodiments are beneficial for a live video production use case where immediate reaction in reducing the media rate from other video sources other than a current live feed may save the live feed from QoE degradation.

In some embodiments, WD 22d is/performs a local camera controller management function (LCCMF) and/or may be the optimal WD 22 to receive load information from network node 16 (e.g., PPU) and/or may be configured to perform local management of other WDs 22 (e.g., production cameras), including managing video quality, audio, location, pan, tilt, zoom, etc.

In some other embodiments, network node 16a (e.g., PPU) may be configured to extract information such as information about a bit flow of packet congestion. The extracted information may be extracted packet information indicative of network performance. The bit flow may include one or more bits such as 1, 0, etc., where 0 means a packet is not congested, 1 means the packet is congested. Network node 16 may be configured to determine when/where to transmit the information, e.g., WD 22d (e.g., LCCMF).

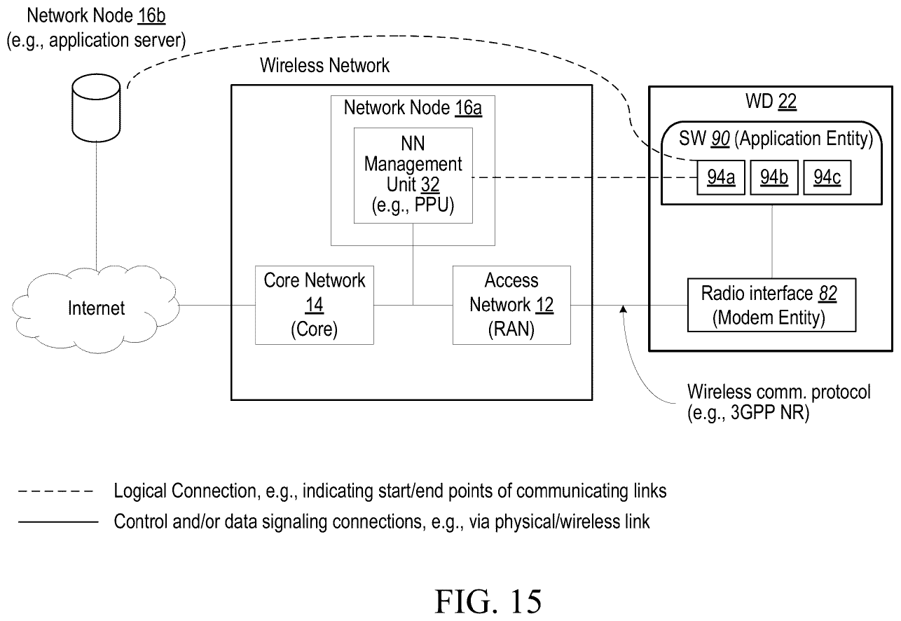

FIG. 15 shows a block diagram of example packet including at least a PPU connection. Network node 16a (and/or NN management unit 32) comprising a PPU, network node 16 connections (e.g., PPU-connections), and WD 22 connections are shown. PPU connections may be to/from WD applications 94 of the WD 22.

WDs 22 may be the transmitter and/or receiver of a payload data transfer, e.g., depending on the type of use cases. WDs 22 may be configured to interact with a wireless network, such as via radio interface 82 (e.g., modem entity) and its communication protocols. Software 90 (e.g., application entity) may comprise and/or operate with one or more WD applications 94 running. Software 90 (e.g., application entity) may be configured to communicates with radio interface 82 (e.g., the modem entity) to transfer information such as on different logical layers.

Software 90 (e.g., the application entity has (via radio interface 82 such as the modem connectivity) a logical connection with network node 16b (e.g., an application server). In one example, this may be a logical application-level connection such as on IP layer where payload data is transferred from a WD application such as an end-user application. The end-user application may include a real time gaming or streaming application.

In one example, software 90 (e.g., application entity) may be configured to initiate a connection to a packet performance unit (PPU) within the wireless network. PPU may be compromised in network node 16a (and/or NN management unit 32), refer to NN management unit 32, and/or perform any of the NN management unit 32 functions. Software 90 (and/or any WD application 94) may configure the PPU to transmit packet delivery performance information indicative of application level real time transfer capability to one or more other network nodes 16 and/or WDs 22, e.g., other than a packet receiver WD 22 and/or a packet receiver network node 16.

Further, software 90 (e.g., application entity) in WD 22 may configure the network node 16a (e.g., NN management unit 32, the PPU) for latency notifications and/or point towards one or more other devices (not shown) to which latency information may be provided once any latency issues occur. The notifications may be based on configured trigger conditions.

The steps and/or processes and/or tasks and/or features performed by software 90 (and/or WD application 94) may be performed in conjunction with any other component of WD 22 such as hardware components.

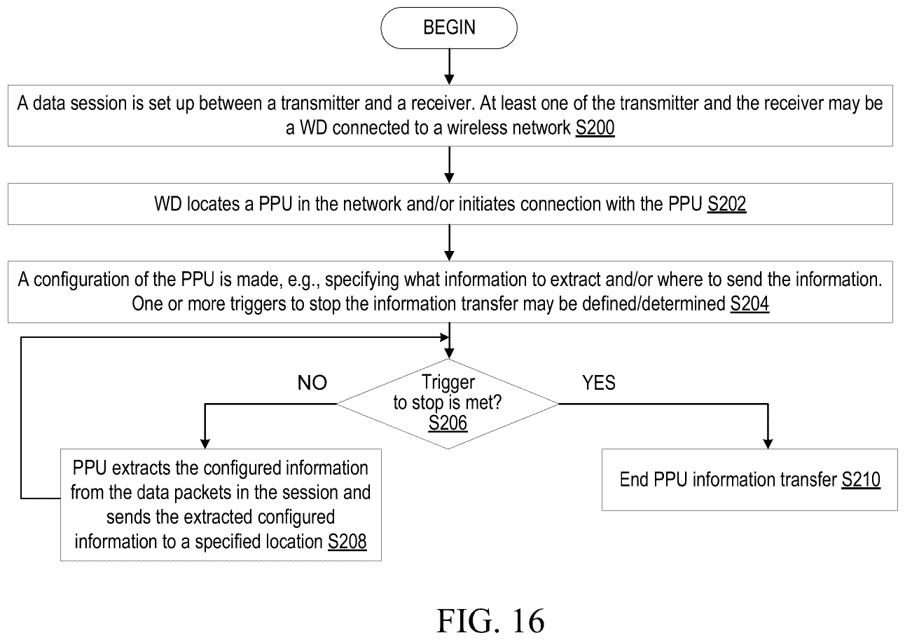

FIG. 16 is a flowchart of another example process according to some embodiments of the present disclosure. More specifically, the process includes steps for a session setup including at least on WD 22. At step S200, a data session is set up (e.g., determined) between a transmitter and a receiver. At least one of the transmitter and the receiver may be a WD 22 connected to a wireless network. At step S202, a WD 22 locates a PPU in the network and/or initiates connection with the PPU. At step S204, a the PPU is configured, e.g., specifying what information to extract and/or where to send the information. One or more triggers to stop the information transfer may be defined/determined and/or included in the configuration. At step S206, the process includes determining whether a trigger stop has been met. At step S208, if the trigger to stop has been met, network node 16 (e.g., PPU) extracts the configured information from the data packets in the session and sends the extracted configured information to a specified location/device. At step S2010, if met, the PPU information transfer is terminated.

In some embodiments, WD 22 device is provided information on whether a network node 16 (e.g., comprising a PPU) is available and how to reach it. This may be provided upon request from WD 22. After a configuration of the PPU (comprised in network node 16), which may involve one or more configuration messages, the network node 16 (e.g., comprising a PPU) may feed the configured WD 22 (e.g., receiver node) with packet specific information until at least one trigger to end the information transfer is met.

In some other embodiments, the packet specific information may be indicative of application-level communication latency on a communication link and/or wireless connection. In one or more examples, the information is extracted from a “Low Latency, Low Loss, Scalable Throughput Internet Service” (L4S) packet indication. The information may be indicative of the congestion notification information which the network node 16 may include on IP packet headers of the data within the payload communication path/link and/or wireless connection. Other information extractions by the network node 16 may be implemented. The packet specific information may in, one or more examples, be indicative of information such as error rates, buffer/data queue volume information, packet latency information, bandwidth usage or similar information which can be extracted from the packet-by-packet delivery of payload data on the communication link.

With respect to signaling, signaling associated with network node 16 (e.g., comprising a PPU) signaling may be implemented on IP layer, with HTTP traffic protocol, on a transport layer and/or on other application-based communication layer. In order words, communication between network node 16 (e.g., comprising a PPU) and other WDs and/or other network nodes 16 (e.g., application server) may be conducted using an Internet Protocol or similar type of communication link. Other options may include 3GPP based signaling, e.g., in radio access protocols for the information sharing in-between WD 22 and the network node 16 (e.g., comprising a PPU). The signaling may use a WD assistance signaling concept or similar communication sharing on RRC layer for the configuration. Low latency information provided from the network node 16 (e.g., comprising the PPU) may use a lower layer signaling flow such as if transmitted over a wireless link.

Some embodiments provide inserting a packet specific information into data packets transmitted to another WD 22, e.g., other than the payload data stream transmitter. For example, since an IP protocol header may include information about the data source IP address as well as the destination IP address, network node 16 (e.g., comprising a PPU) may be aware of data to the appointed node. Packet specific information may also be included in packets transmitted to the IP packet that targets an IP address. In other words, the information can be inserted into packets in the indicated direction to the receiver of the notification. Further, some embodiments provide arrangements for very low latency and/or sending feedback to a device/node other than the data source transmitter.

In addition, network node 16 (e.g., comprising a PPU) may use an explicit congestion notification (ECN) implementation, where PPU functions described in the present disclosure are implemented via direct introduction of so-called ECN-Echo signal into data packets transferred to the packet stream source. Since ECN-Echo (ECE) may be used within TCP to echo back a congestion indication (i.e., signal the sender to reduce the transmission rate), one method to reach fast feedback of such congestion information to a transmitter may be for the network node 16 to include the ECE signal directly into a first available packet in a direction towards an indicated WD 22 and/or network node 16 (e.g., when the network node 16 intends to include an ECN bit into the payload data packet). In some examples, this direct inclusion of ECN signal (e.g., to a data source) may replace any potential ECN signal inclusion into the data to a data receiver, such as to not confuse or repeat indication signaling.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ECN Explicit congestion notification
ECE ECN-Echo
L4S Low Latency, Low Loss, Scalable Throughput Internet Service
PPU Packet performance unit (proposed here as IVD naming of the new network functionality and interface)
RRC Radio resource control
IP Internet packet
VR Virtual reality
XR Extended Reality
AI Artificial Intelligence

### Dash Dynamic Adaptive Streaming over HTTP

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first wireless device, WD, configured to communicate with a network node, the network node being configured to communicate with a set of second WDs, the first WD and each WD of the set of second WDs being configurable to perform at least one or more actions to provide a common function, the first WD comprising:
processing circuitry configured to:
determine a network configuration for the network node to transmit a notification to the set of second WDs when the first WD experiences a congestion condition, the notification indicating at least one WD of the set of second WDs to perform a compensation action to maintain a seamless continuity of the common function; and
a radio interface in communication with the processing circuitry, the radio interface being configured to:
transmit the determined network configuration to the network node.

2. The first WD of claim 1, wherein the network configuration includes data stream information about a data stream associated with the first WD, the data stream information triggering the network node to monitor the data stream to determine that the first WD is experiencing the congestion condition and to transmit the notification to the set of second WDs.

3. The first WD of claim 1, wherein the network configuration is transmitted to the network node when a data session setup corresponding to the first WD is completed.

4. The first WD of claim 1, wherein the network configuration includes at least one identifier of at least one WD of the set of second WDs.

5. The first WD of claim 1, wherein the network configuration includes at least one trigger for the network node to transmit the notification, the at least one trigger being based on at least one of a packet latency value associated with at least one packet corresponding to the first WD.

6. The first WD of claim 1, wherein the network configuration includes a capability indication indicating a plurality of parameters associated with the congestion condition.

7. The first WD of claim 1, wherein the notification is transmitted to the set of second WDs, and the compensation action is performed within a predetermined latency range.

8. The first WD of claim 1, wherein the compensation action includes a reduction of data rate associated with at least one WD of the set of second WDs.

9. The first WD of claim 1, wherein the at least one or more actions to provide the common function includes sharing data, within a predetermined latency range, between the first WD and at least one WD of the set of second WDs.

10. The first WD of claim 1, wherein the common function includes one or more of:
a process associated with a common software application, the common software application being used by the first WD and at least one WD of the set of second WDs to share data;
a video streaming from the first WD and at last one WD of the set of second WDs; and
an industrial control function to at least one of control and monitor the first WD and at least one WD of the set of second WDs.

11. A method in a first wireless device, WD, configured to communicate with a network node, the network node being configured to communicate with a set of second WDs, the first WD and each WD of the set of second WDs being configurable to perform at least one or more actions to provide a common function, the method comprising:
determining a network configuration for the network node to transmit a notification to the set of second WDs when the first WD experiences a congestion condition, the notification indicating at least one WD of the set of second WDs to perform a compensation action to maintain a seamless continuity of the common function; and
transmitting the determined network configuration to the network node.

12-30. (canceled)

31. A method in a network node configured to communicate with a first wireless device, WD, and a set of second WDs, the first WD and each WD of the set of second WDs being configurable to perform at least one or more actions to provide a common function, the method comprising:
receiving, from the first WD, a network configuration for the network node to transmit a notification to the set of second WDs when the first WD experiences a congestion condition, the notification indicating at least one WD of the set of second WDs to perform a compensation action to maintain a seamless continuity of the common function;
determining the notification based on the received network configuration; and
transmitting the notification to at least one WD of the set of second WDs.

32. The method of claim 31, wherein the network configuration includes data stream information about a data stream associated with the first WD, and the method further includes:
monitoring the data stream; and
determining that the first WD is experiencing the congestion condition.

33. The method of claim 31, wherein the network configuration is received by the network node when a data session setup corresponding to the first WD is completed.

34. The method of claim 31, wherein the network configuration includes at least one identifier of at least one WD of the set of second WDs, and the method further includes:
determining the at least one WD of the set of second WDs to transmit the notification based on the at least one identifier.

35. The method of claim 31, wherein the network configuration includes at least one trigger for the network node to transmit the notification, the at least one trigger being based on at least one of a packet latency value associated with at least one packet corresponding to the first WD, and the method further includes:
determining the at least one trigger based on the network configuration; and
transmitting the notification based at least one the at least one trigger.

36. The method of claim 31, wherein the network configuration includes a capability indication indicating a plurality of parameters associated with the congestion condition, and the method further includes:
determining the plurality of parameters associated with the congestion condition; and
transmitting the plurality of parameters to at least one WD of the set of second WDs.

37. The method of claim 31, wherein the notification is transmitted to the set of second WDs, and the compensation action is performed within a predetermined latency range.

38. (canceled)

39. The method of claim 31, wherein the at least one or more actions to provide the common function includes sharing data, within a predetermined latency range, between the first WD and at least one WD of the set of second WDs.

40. The method of claim 31, wherein the common function includes one or more of:
a process associated with a common software application, the common software application being used by the first WD and at least one WD of the set of second WDs to share data;
a video streaming from the first WD and at last one WD of the set of second WDs; and
an industrial control function to at least one of control and monitor the first WD and at least one WD of the set of second WDs.
